(19) United States
(12) Patent Application Publication
(10) Pub. No.: US 2002/0067428 A1
(43) Pub. Date: Jun. 6, 2002

(54) System and method for selecting symbols on a television display

(76) Inventor: Paul M. Thomsen, Bonita, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/881,142

(22) Filed: Jun. 14, 2001

Related U.S. Application Data
(60) Provisional application No. 60/250,835, filed on Dec. 1, 2000.

(51) Int. Cl. G06F 3/00; H04N 5/445; G06F 13/00; H04N 7/00; H04N 11/00

(52) U.S. Cl. 348/465; 348/461; 348/468

(57) ABSTRACT

A system and method for selecting symbols on a television display. In response to a viewer request, the television maintains closed caption information on the television display. The viewer may then select and retrieve additional information regarding the selected symbols. For example, in response to selecting a word of the closed caption information, in one embodiment of the invention, the television queries an external device such as Internet search engine for additional information. The external device can comprise other types of database systems such governmental, private, educational, and commercial databases. Furthermore, in one embodiment of the invention, the television queries an internal database of the television to find the requested information.

### RELATED APPLICATION

The present application claims priority to and incorporates by reference, in its entirety, U.S. Provisional Application No. 60/250,835, filed on Dec. 1, 2001, and titled “SYSTEM AND METHOD FOR SELECTING TEXT ON A TELEVISION DISPLAY”.

### BACKGROUND OF THE INVENTION

1. Field of the Invention

The field of the invention relates to televisions. More particularly, the field of the invention relates to a system and method for selecting symbols on a television display.

2. Description of the Related Technology

Closed caption information is commonly used by televisions to display transcribed on-screen dialog and lyrics. Closed caption information typically includes control codes that indicate the placement of the closed caption information and information defining the duration of time that the closed caption information should be displayed.

Unfortunately for viewers, reading closed caption information is a relatively non-interactive experience. For example, some televisions provide limited interactive capability with respect to URLs (“Uniform Resource Locators”). A URL is an address for a resource on a network such as the Internet. The first part of a URL address indicates a protocol that is used use to access the resource, and the second part of the URL address specifies the IP address or the domain name where the resource is located. These televisions provide the limited capability of allowing a viewer to select an icon that is associated with a received URL.

However, disadvantageously, known systems do not allow viewers to maintain a portion of the scrolled closed caption data on the television screen and interactively select one or more symbols of the data. Known systems simply passively scroll and display closed caption data to a viewer as it is received. Using these systems, it is not possible for a viewer to obtain further information regarding items of text in the closed caption data.

Consequently, there is a need for a system and a method for allowing a viewer to display and select data from scrolling closed caption information. The system and method should also allow the viewer to retrieve additional information regarding the selected information.

### SUMMARY OF THE INVENTION

One aspect of the invention comprises a method of selecting symbols on a television display, the method comprising receiving a video signal that comprises closed caption data, wherein the closed caption data includes a plurality of symbols, displaying the closed caption data on the television display, storing at least portion of the closed caption data in a buffer, receiving, via a remote control device, first control instructions to maintain the displayed closed caption data on the television display until the occurrence of a selected event, wherein the selected event is one of: receipt of second control instructions to resume the display of the closed captioned data in the video signal, the passage of a predetermined amount of time, or receipt of third control instructions requesting the selection of at least one of the symbols, receiving, via the remote control device, the third control instructions to select at least one of the symbols; highlighting the selected symbols on the television display, and transmitting the selected symbols to a database system.

Another aspect of the invention comprises a television, the television comprising a remote control device for receiving control instructions from a user, and a controller for receiving and displaying a video signal that comprises closed caption data, wherein the closed caption data includes a plurality of symbols, wherein in response to receiving first control instructions from a user, the controller maintains a selected portion of the closed caption data on the television display until the occurrence of a selected event, wherein the selected event is either: receipt of second control instructions to resume the display of the closed caption data in the video signal, the passage of a predetermined amount of time, or receipt of third control instructions requesting the selection of at least one of the symbols, and wherein, in response to receiving, via the remote control device, the third control instructions to select at least one of the symbols, the controller highlights the selected symbols on the television display.

Yet another aspect of the invention comprises a television, the television comprising an interface for receiving control instructions from a user, and a controller for receiving and displaying a video signal that comprises data, wherein the data includes a plurality of symbols, wherein in response to receiving first control instructions from a user, the controller maintains at least some of the symbols on the television display, and wherein the controller receives second control instructions to select one or more of the symbols on the television display.

Yet another aspect of the invention comprises a system for selecting symbols on a television display, the system comprising: means for receiving a video signal that comprises data, wherein the data includes a plurality of symbols, means for displaying the data, means, responsive to a user request, for maintaining a selected portion of the data on the television display, and means, responsive to a user request, for selecting at least a portion of one of the words on the television display.

### BRIEF DESCRIPTION OF THE DRAWINGS

FIG. 1 is a block diagram illustrating certain components of an analog television in accordance with one embodiment of the invention.

FIG. 2 is screen display illustrating closed caption text that can be displayed by the television illustrated in FIG. 1.

FIG. 3 is a block diagram illustrating in further detail components of the television controller that is shown in FIG. 1.

FIG. 4 is a block diagram illustrating certain components of a digital television in accordance with one embodiment of the invention.

FIGS. 5A-5C are collectively a flowchart illustrating a process of selecting data from closed caption information that is performed by the video controller of FIG. 1.

FIG. 6 is an exemplary screen display that can be displayed by the television of either FIGS. 1 or 4.

FIG. 7 is a an exemplary screen display of a menu that can be displayed by the television of either FIGS. 1 or 4.

FIG. 8 is an exemplary screen display of certain closed caption information that is presented to the viewer by the television of either FIGS. 1 or 4.

FIG. 9 is an exemplary screen display showing that the word “EPA” has been selected by a viewer.

FIG. 10 is an exemplary screen display illustrating the results of a search based upon the keyword “EPA.”

### DETAILED DESCRIPTION OF THE EMBODIMENTS OF THE INVENTION

The following detailed description is directed to certain specific embodiments of the invention. However, the invention can be embodied in a multitude of different ways as defined and covered by the claims.

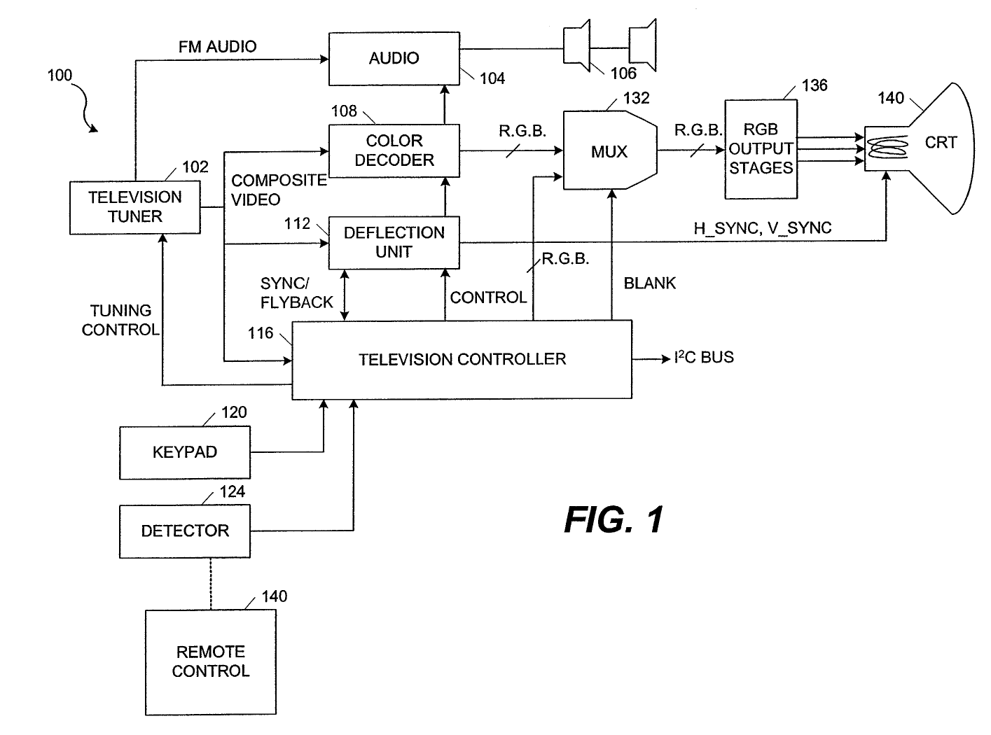

FIG. 1 is a block diagram illustrating certain components of an analog television 100 in accordance with one embodiment of the invention. The television 100 includes a television tuner 102 for receiving analog signals. The television tuner 102 is electrically connected to a speaker 106 via an audio component 104, a color decoder 108, a deflection unit 112 and a television controller 116. The television tuner 102 receives an analog audio/video signal and transmits the audio portion of the audio/video signal to the audio component 104 and the video component to the color decoder 108, the deflection unit 112, and the television controller 116. Furthermore, the television tuner 102 receives closed caption information via the video signal. For example, EIA/CEA-608-B is a standard developed by the EIA that uses line 21 of a television signal's vertical blanking interval (VBI) to transmit closed caption information.

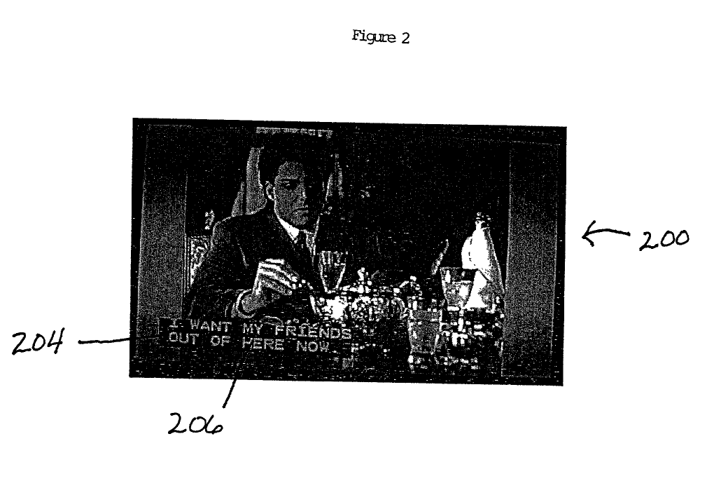

An example of closed caption information is shown in closed caption box 204 of the screen display 200 of FIG. 2. The closed caption box 204 includes a plurality of symbols 206. The symbols 206 can include text, numbers, punctuation characters, graphical characters such as musical notes, and the so forth. Caption information typically contains transcribed on-screen dialogue and lyrics.

Known closed captioning standards provide for a minimum level of support with respect to character sets, colors and control codes that control the on-screen location and appearance of the closed captions. Known standards also define the method of encoding these characters and control codes in a manner that is consistent from channel to channel among TV stations and among content providers.

The color decoder 108 and the television controller 116 are each connected to a multiplexor (MUX) 132 that sends video signals to an Red/Green/Blue (RGB) output stages module 136. The RGB output stages module 136 displays the video signals to a cathode ray tube (CRT) 140.

The television controller 116 is also connected to a keypad 120 and an infra-red (I/R) detector 124. The keypad 120 is used by the viewer to input control instructions to adjust the programmable features of the television 100. For example, using the keypad 100, the viewer can change the channel or adjust the volume. The device 140 can provide the same type of control instructions to the television controller 116 as the keypad 120.

The television controller 116 includes certain modules of software, microcode, hardware, or a combination thereof. As can be appreciated by one of ordinary skill in the art, each of the software modules comprise various sub-routines, procedures, definitional statements, and macros. The television controller 116 receives control instructions from the keypad 120 or the remote control device 140. The television controller 116 displays a cursor and television generated menu on the television screen so as to allow the viewer to turn on or off or otherwise adjust the programmable features of the television 100.

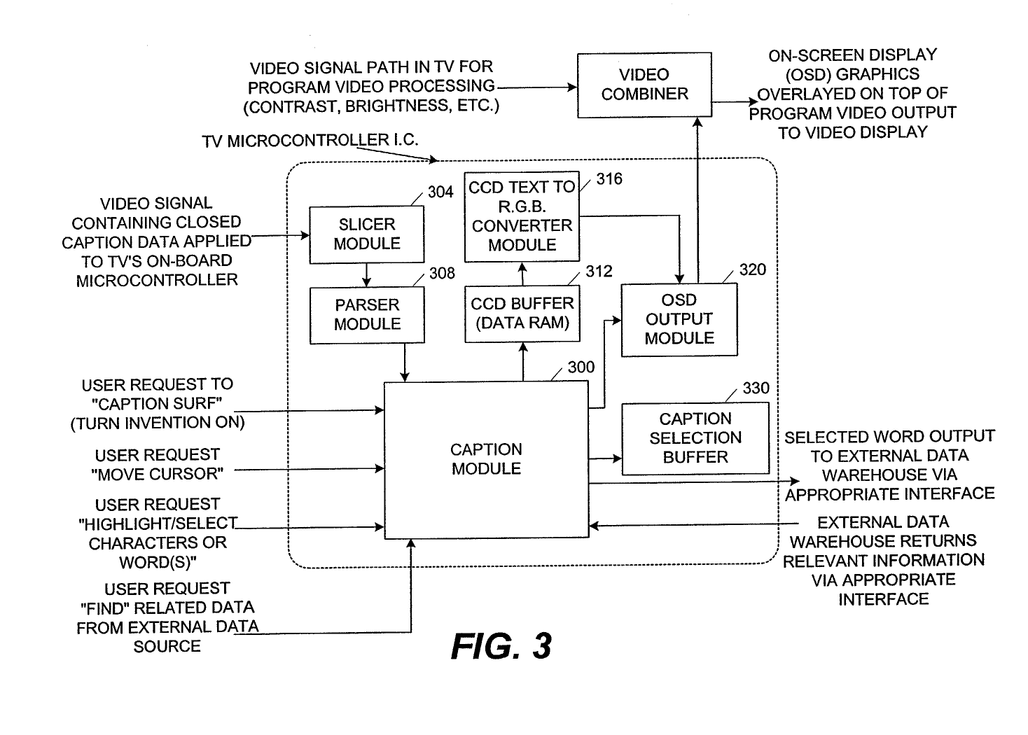

FIG. 3 is a block diagram illustrating certain components of the television controller 116. The television controller 116 includes a caption module 300, a slicer module 304, a parser module 308, a closed caption display (CCD) buffer 312, a closed caption display text to red/green/blue converter module 316, and an on-screen display output module 320. In one embodiment of the invention, in contrast to the caption module 300, the functions of the modules 304-320 are conventional and are well-known to one of ordinary skill in the art.

Depending on the embodiment, the caption module 300 can do all or selected ones of the following features: (i) enable the display of closed captions when instructed by the viewer; (ii) “freeze” the scrolling of on-screen captions when instructed by the viewer; (iii) present a “cursor” or other marker on-screen to the viewer thereby allowing the viewer to “point” to a word or words within the frozen closed caption display area on-screen; (iv) relate the on-screen selected word(s) to closed caption data stored in a caption buffer memory; (v) identify from that relation the specific word(s) in the closed caption buffer; (vi) copy the selected buffer memory locations to a second buffer; (vii) strip away the control codes before/after the buffer's contents; (viii) transmit the second buffer's processed data to an external device; (ix) transmit instructions to the external device to search for content that contains or matches the second buffer's content; and (ix) display the result that are provided by the external device. It is also to be appreciated by one of ordinary skill in the art that all or some of foregoing features can be performed by another hardware or software component of the television 100. Furthermore, depending on the embodiment, the caption module 300 and the modules 304-320 can be implemented in hardware, software, or a combination thereof. In one embodiment of the invention, a caption selection buffer 330 is connected to the caption module 300.

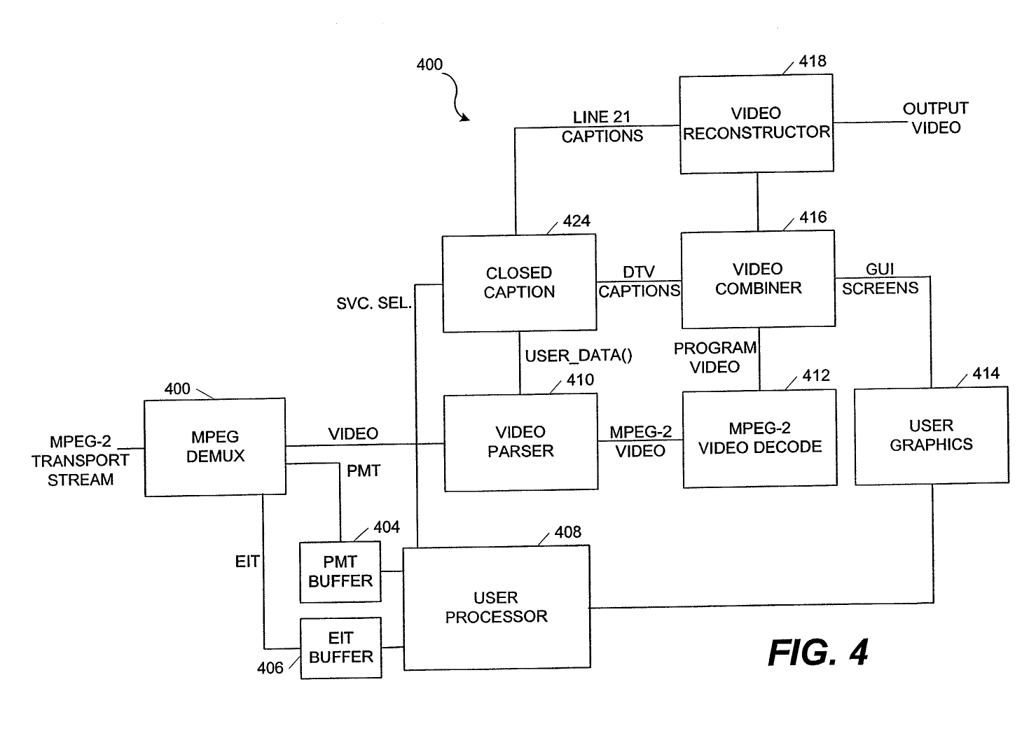

FIG. 4 is a block diagram illustrating certain components of a digital television 400 in accordance with one embodiment of the invention. The digital television 400 includes a number of conventional digital television components such as an MPEG demultiplex 132, a PMT buffer 404, an EIT buffer 406, a user processor 408, a video processor 410, a MPEG-2 video decode module 412, a user graphics module 414, a video combiner 416 module, and a video reconstructor module 418.

The digital television 400 also includes a closed caption decoder 424 for decoding closed caption information according to either the EIA/CEA-608-B standard discussed above or, alternatively, closed caption information from the EIA-708-B standard. The EIA-708-B standard, titled “Digital Television (DTV) Closed Captioning”, dated November 1998, is hereby incorporated by reference, in its entirety.

In addition to providing conventional functions, in one embodiment of the invention, the closed caption decoder 324 allows the viewer perform each of the functions described above with respect to the caption module 300. In another embodiment of the invention, one or more features provided by the caption module 300 are provided by components of the television 400 other than the closed caption decoder 324.

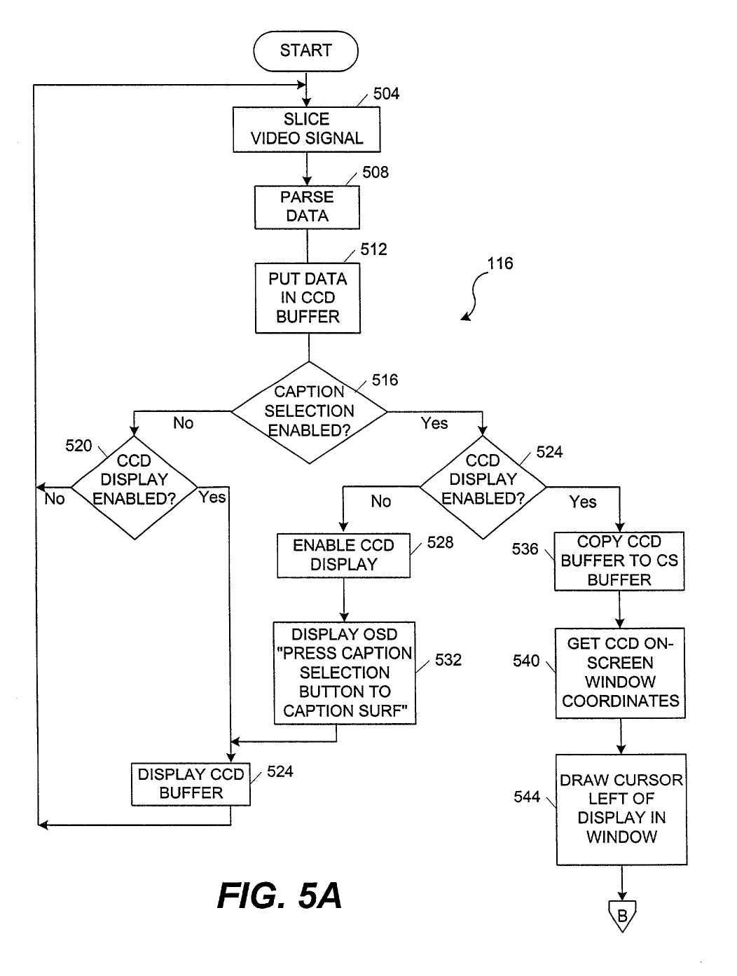

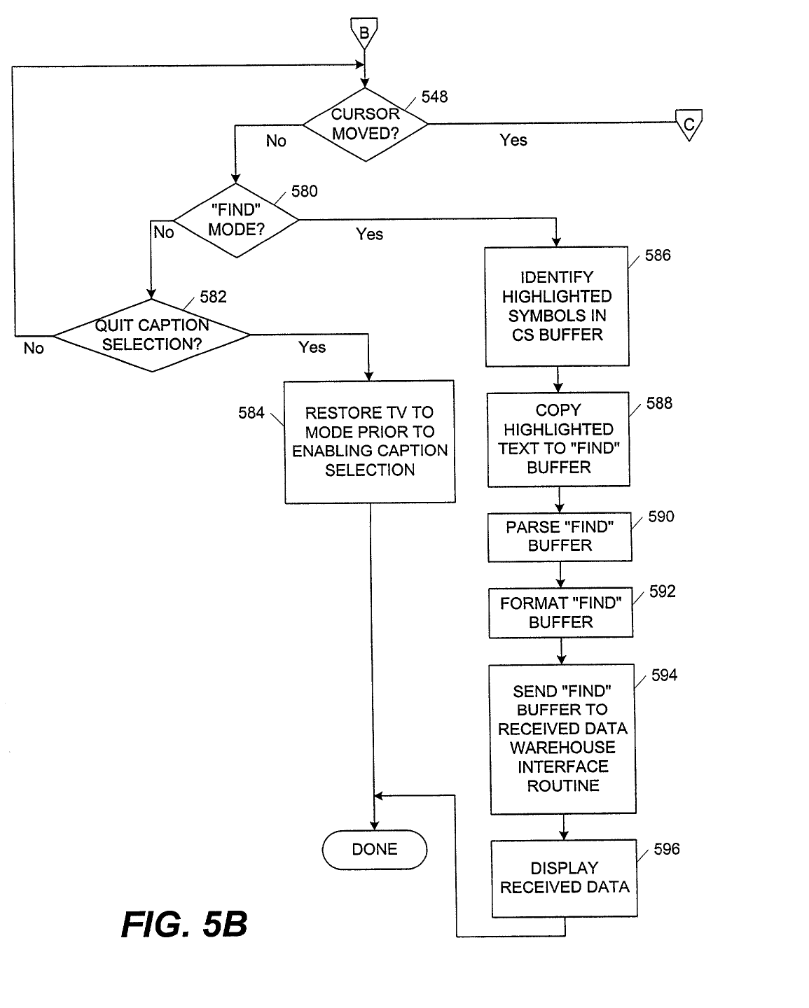

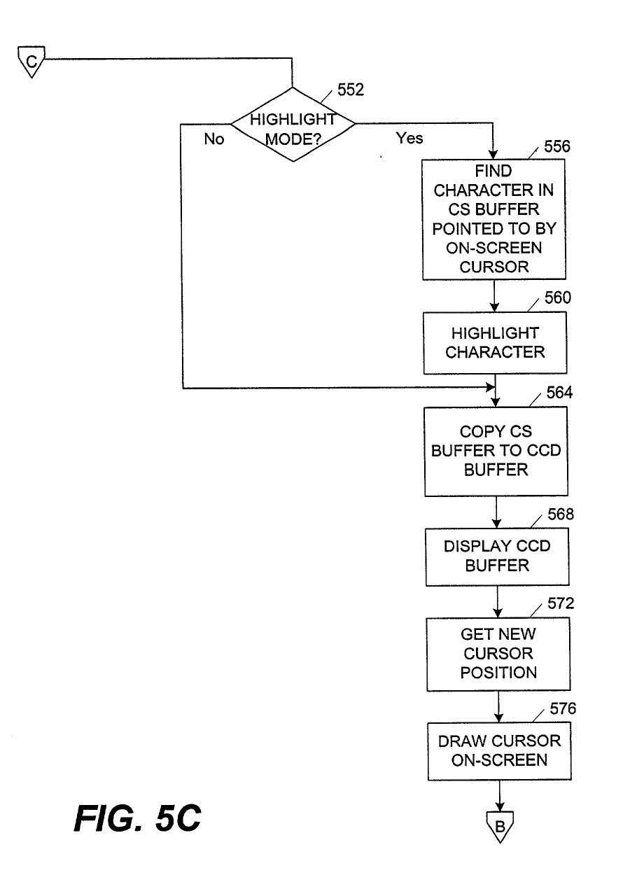

FIGS. 5A-5C are collectively a flowchart illustrating a process of processing an audio/video signal. In one embodiment of the invention, the process is performed by the television controller 116. However, it is also to be appreciated by one of ordinary skill in the art one or more or all of the steps may be performed by components of the television 300 other than that of the television controller 116. Furthermore, depending on the embodiment, additional steps may be added, selected steps may be deleted, and the ordering of the steps may be rearranged.

Starting at a step 504, the television controller 116 slices the incoming video stream. At this step, in one embodiment of the invention, the television controller 116 identifies line 21 of the vertical blanking interval and extracts vertical blanking data from the video signal.

Continuing to a step 508, the television controller 116 parses the extracted vertical blanking data into its constituent pieces, e.g., closed captioned (CC) data. Moving to a step 512, the television controller 116 stores parsed CC data into the CCD buffer 312.

Proceeding to a decision step 516, the television controller 116 determines whether caption selection is enabled. Caption selection may be enabled by the viewer via a control instructions from the keypad 120 or the remote controller 140. In response to caption selection, the television controller 116 stops the scrolling of closed caption information so as to allow the viewer to select one or more symbols of the closed caption information. The television controller 116 maintains the closed caption information on the television 300 until the occurrence of a selected event. The selected event can include the lapse of a predetermined period of time without having received control instructions from the user or the viewer selection of one or more of the displayed symbols.

If caption selection is disabled, the television controller 116 proceeds to a decision step 520 wherein the television controller 116 determines whether the viewer has enabled the display of closed caption data. If closed caption is disabled, the process returns to the step 504. If the closed caption is enabled, the television controller 116 proceeds to a step 524, and the television controller 116 causes the content of the CCD buffer 312 to be displayed on the television screen. The process flow then returns to the step 504.

Referring again to the decision step 516, if caption selection is enabled, the television controller 116 proceeds to a decision step 524. At the decision step 524, the television controller 116 determines whether the closed caption display is enabled. The display of closed captioned information may be configurably enabled and disabled by the viewer via the keypad 120 and the remote controller 140. If the closed caption display is not enabled, the television controller 116 proceeds to a step 528 and automatically enables the closed caption display of data. Moving to a step 532, the television controller 116 notifies the viewer that the viewer should use a “caption selection” button on the keypad 120 or on the remote control 140 to initiate caption selection. The television controller 116 then proceeds to the step 524 (discussed above).

Referring again to the decision step 524, if closed caption display is enabled, the television controller 116 proceeds to a step 536, wherein the television controller 116 copies the CCD buffer 312 to the caption selection buffer 330. Next, at a step 540, the television controller 116 determines the on-screen coordinates of the closed caption window. Moving to a step 544, the television controller 116 draws a cursor at a selected position in the closed caption window. In one embodiment of the invention, the television controller 116 places the cursor in the bottom leftmost position in the television window. However, it is to be appreciated by one of ordinary skill in the art that other positions may be used.

Continuing to a decision step 548 (FIG. 5B), the television controller 116 determines whether the viewer has moved the cursor via the keypad 120 or the remote control 140. If the cursor moved, the television controller 116 proceeds to a decision step 552 (FIG. 5C). Steps 552-576 describe how in one embodiment of the invention the television controller 116 allows the viewer to move a cursor on the screen and highlight individual symbols on the television display. In another embodiment of the invention, in response to the selection of a selected symbol, the video controller 116 automatically selects and highlights all of the other symbols that are nearby and that are between certain delimiters such as a space. This advantageously reduces the number of cursor and other control instructions that are needed by the viewer to select a group of symbols. It is to be appreciated by one of ordinary skill in the art that other methods may be employed to select and highlight the text.

At the decision steps 552, the television controller 116 determines whether the viewer has invoked a “highlight” mode. In the highlight mode, the viewer may select one or more of the symbols that are displayed on the television. If the viewer has invoked the “highlight mode”, the process proceeds to a step 556. At the step 556, the television controller 116 finds the character in the caption selection buffer 330 that is identified by the on-screen cursor. Next, at a step 560, the television controller 116 modifies the control codes of the character selected by the cursor such that it is highlighted with respect to the other characters.

From either the step 560, or alternatively, from the step 552 if the viewer did not invoke the highlight mode, the television controller 116 proceeds to a step 564 wherein the contents of the caption selection buffer 330 is copied into the CCD buffer 312. Moving to a step 568, the television controller 116 displays the contents of the CCD buffer 312.

Next, at a step 572, the television controller 116 determines the new cursor position, i.e., whether the viewer moved the cursor up, down, to the right, or to the left. Continuing to step 576, the television controller 116 draws the cursor at the new position. The television controller 116 then returns to the step 548 to await further control instructions from the viewer to move the cursor or, perform a predefined action with respect to the highlighted symbols. The process then returns to the decision step 548 (FIG. 5B).

Referring again to the step 548, if the viewer has not moved the position of the on-screen cursor, the television controller 116 proceeds to a decision 580 wherein it is determined whether the viewer has invoked a “find” mode of the television. The find mode is invoked in response to the viewer providing certain control instructions to the television controller 116 via the keypad 120 or the remote control 140. For example, in one embodiment of the invention, the keypad 120 and the remote controller 140 each include a “find” button. In response to selecting the find button, the video controller 116 performs the steps 586-596 (discussed below).

If the viewer did not invoke the find mode of the television controller 116, the video controller 116 proceeds to a decision step 582. At this decision step, the video controller 116 determines whether the viewer requested to exit the caption selection process. If the viewer requested to exit the caption selection process, the process flow proceeds to a step 584, wherein the video controller 116 restores the television to the mode it was in prior to viewer requesting to perform caption selection. Referring again to the decision step 582, if the viewer did not request to exit caption selection, the process flow returns to the decision step 548.

Referring again to the decision step 580, if the viewer invoked the find mode of the television, the process flow proceeds to a step 586 wherein the video controller identifies 116 the symbols that were selected by the viewer during the steps 556 and 560 (discussed above). Next, at a step 588, the video controller 116 copies the highlighted text to a find buffer. Continuing to a step 590, the video controller 116 parses the find buffer to remove extraneous control codes from the data corresponding to the identified symbols.

Moving to a step 592, the video controller 116, if necessary, formats the content of the data in the find buffer to a suitable format for transmission to a data warehouse. The data warehouse can be for example: a database application on the television, an Internet search engine, or an external database, such as is provided by many commercial, governmental, and educational institutions.

Continuing to a step 594, the video controller 116 sends the content of the find buffer to the data warehouse. The connection to the data warehouse can established via any one of a number of interfaces such as USB, IEEE1394, RS-232, I²C, wireless, cellular, Ethernet, HomePNA, etc., etc. In one embodiment of the invention, the video controller 116 activates a viewing program on the television so as to allow the viewer to view and access the data that is returned by the data warehouse. For example, in one embodiment of the invention, the viewing program is an Internet browser.

The data warehouse is configured to receive the data and, in automatic response thereto, return information that is related to the transmitted data. Next at a step 596, the video controller 116 displays the received data from the data warehouse on the television.

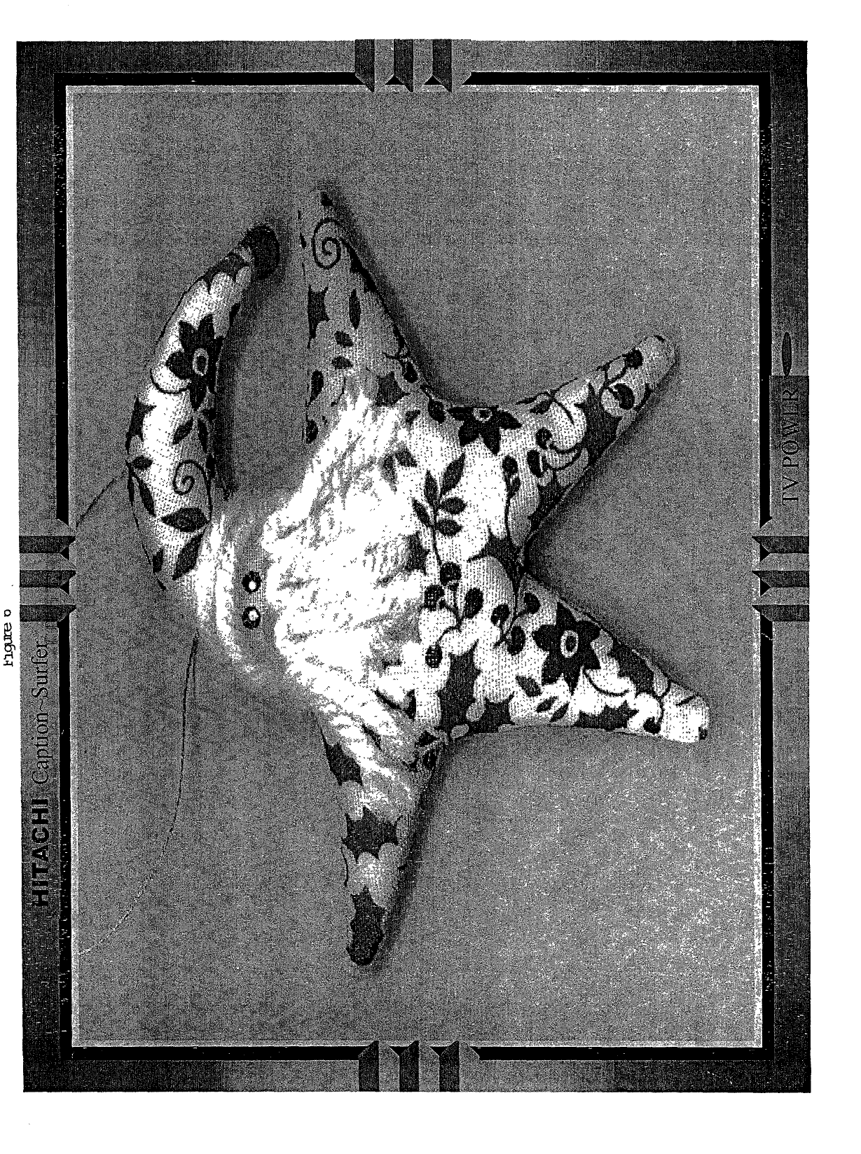

FIGS. 6-11 are exemplary screen displays of a television during certain points during the process described above with respect to FIG. 5. These figures represent only one example of an embodiment of the invention and are not intended to limit the scope of the invention.

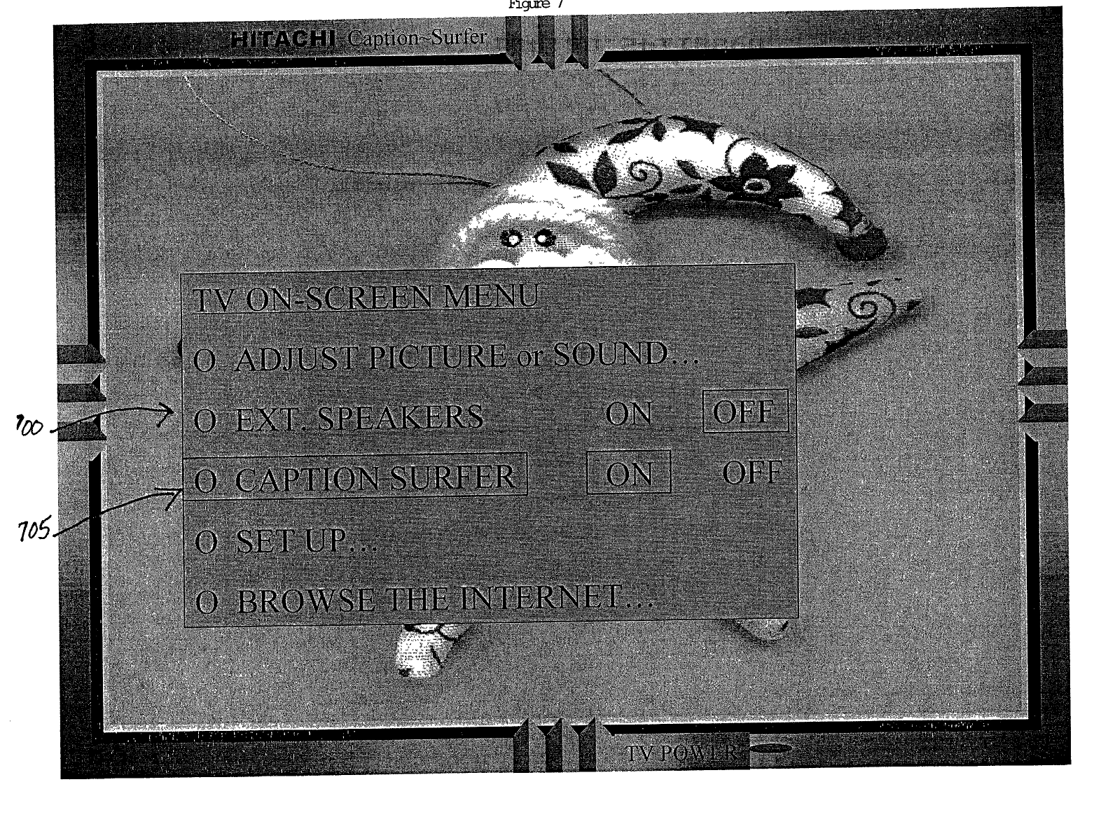

FIG. 6 is a screen display of a television show regarding a Santa ornament. FIG. 7 illustrates the screen display of FIG. 6 subsequent to the viewer opening a control window on 700 the screen of the television. The control window 700 may be opened via the keypad 120 or the remote control 140. The control window 700 includes a number of control settings 705 that may be set by the viewer. For example, as is shown in FIG. 7, the viewer can toggle off and on a “caption surfer” setting. Enabling caption surfing allows the viewer to stop the scrolling of closed caption information on the television and select one or more symbols of the closed caption information (discussed above with respect to FIG. 5).

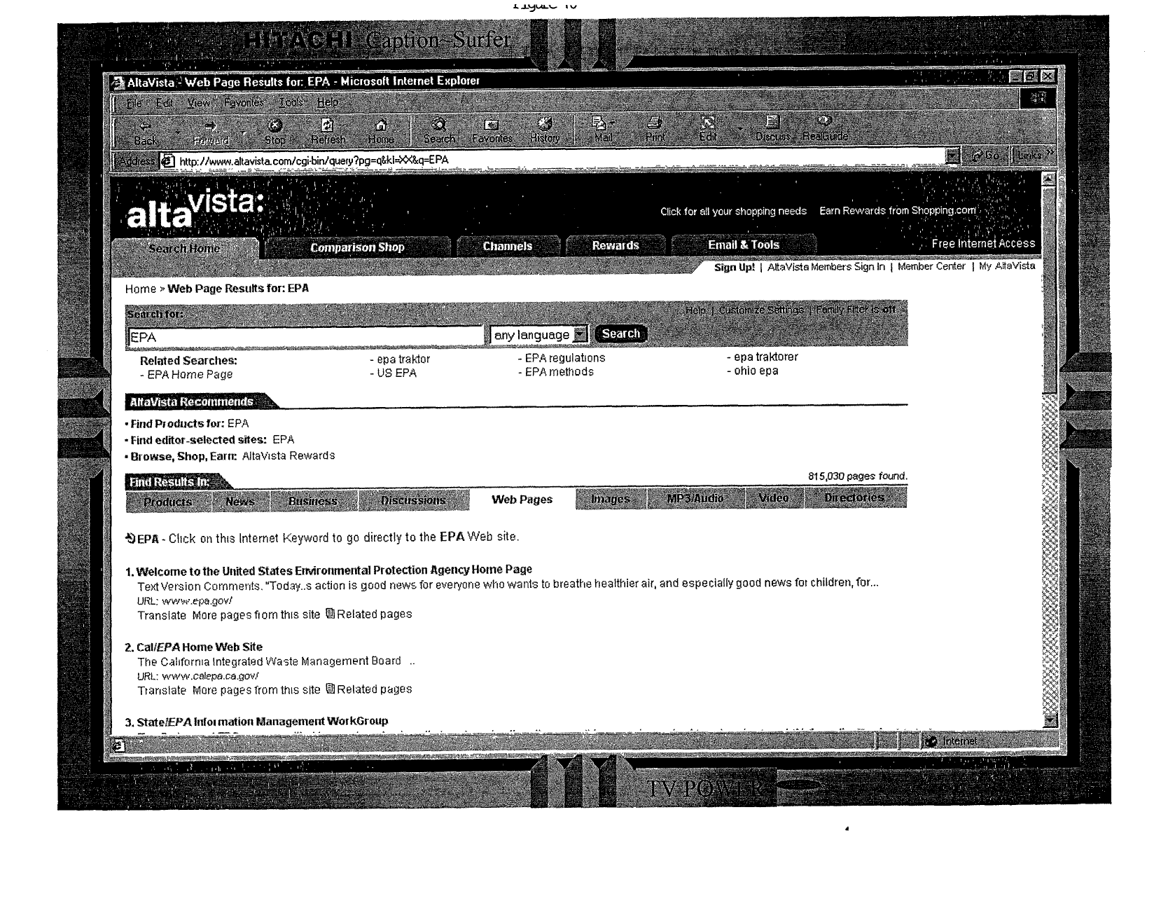

FIG. 8 is a screen display illustrating a caption closed caption window 804. As is shown in FIG. 8, the video controller 116 has stopped the scrolling of the closed caption information. The video controller 116 maintains the closed caption window 804 on the screen until the viewer selects one or more of the symbols or upon the occurrence of a selected event such as discussed above with respect to step 552 of FIG. 5. As is shown in FIG. 5, the viewer has moved the cursor 806 to point to the word “EPA” in the closed caption window 804. It is noted that although the cursor 806 is an arrow, other forms of cursors may be employed, e.g., a flashing block, a hand, or other such icon.

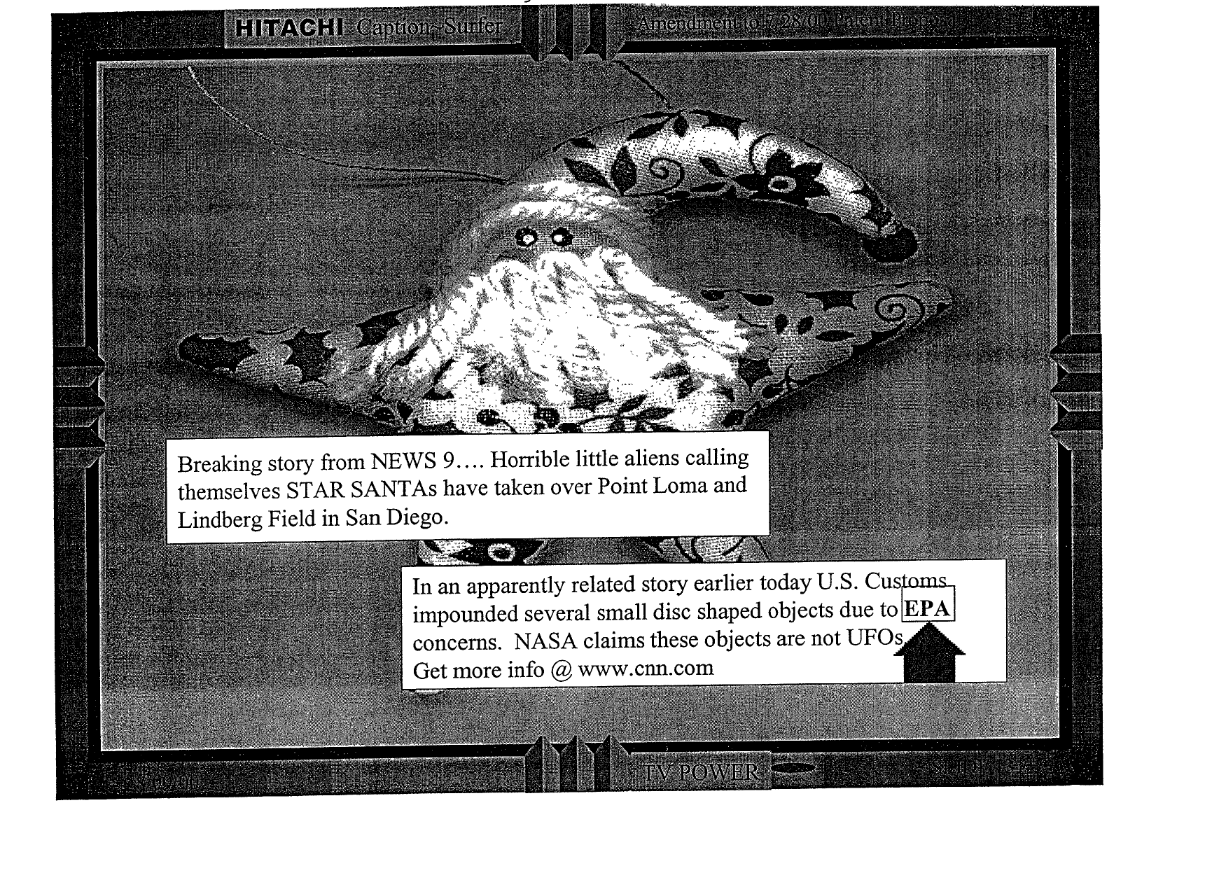

Referring to FIG. 9, the viewer has selected the word “EPA” and the word is graphically highlighted by the video controller 116. After selection, the television controller 116 transmits the selected word and control instructions to a data warehouse. The control instructions request the data warehouse to provide information regarding selected word.

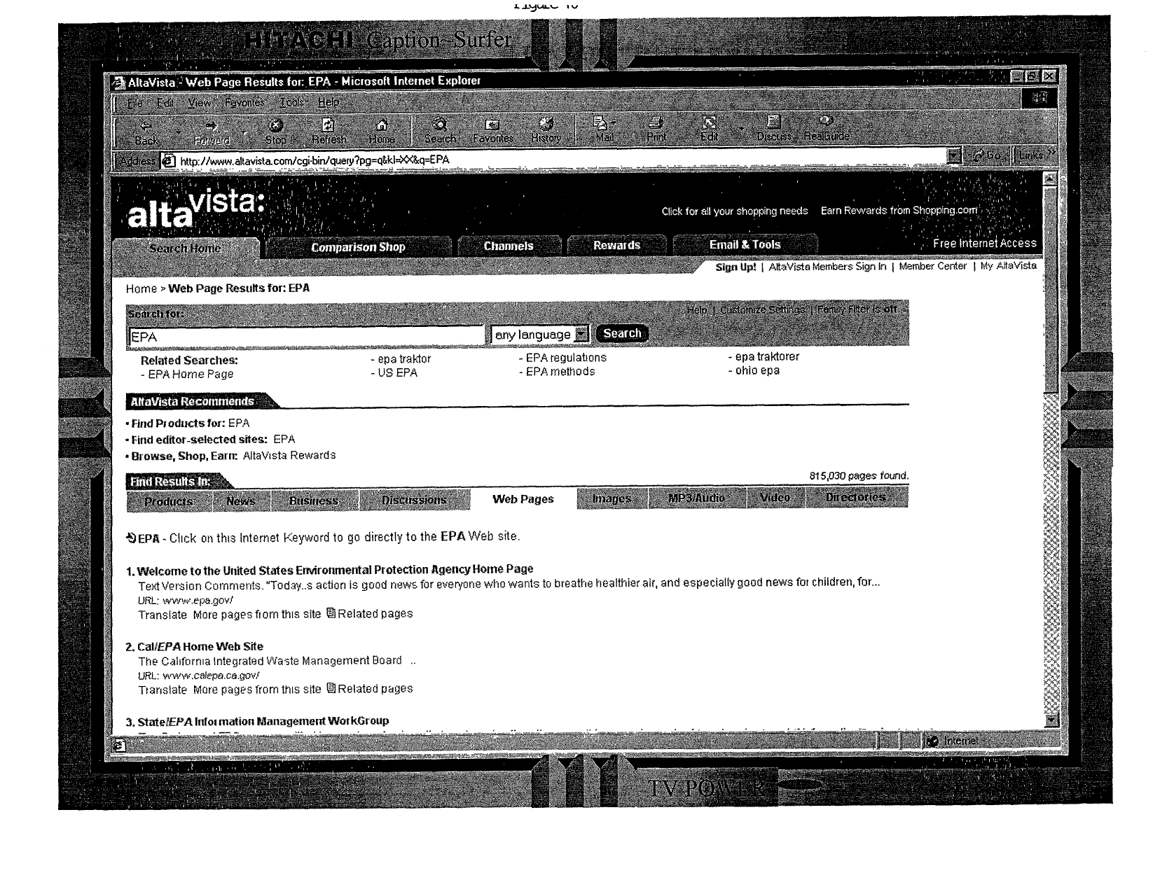

FIG. 10 illustrates the results of the search based upon the search term “EPA.” Once the search is complete, the viewer can continue using an Internet browser to find more information regarding the search term. For example, as is shown in FIG. 11, the viewer can use the remote control 140 to select the first entry of the search results and visit the Environmental Protection Agency home page.

It is to be appreciated that although FIG. 10 and 11 show an Internet browser, e.g., Microsoft's Internet Explorer Version 5.0, there are a number of types of viewing programs that can be used. Also should be appreciated that the television may be built upon existing hardware and software within known television systems.

Caption selection as is discussed above with respect to FIG. 5 may also be performed on a personal computer (PC) having a television tuner card which supports closed caption decoding. Control software of the computer can be generated to do the following: (i) read the television's tuner card's CCD buffer; (ii) allow the customer to move the PC's mouse to select a desired word or group of words or other element; (iii) select one or more symbols from the data in the CCD buffer; and (iv) pass that symbols (after stripping away control codes, etc.) to an Internet browser on the PC.

In one embodiment, the video controller 116 identifies and stores Universal Resource Locators (URLs) that are sent as part of the closed caption information. When located in the CCD buffer 312, the URLs are automatically copied and stored in a storage area. Later, the URLs can be retrieved by the viewer and selected for use as search terms.

Advantageously, using the television controller 116, a viewer can select keywords from closed caption data services commonly in use by today's television, movie studios (VCR & DVD rentals) or virtually any other data source supplying EIA/CEA-608-B compliant VBI and EIA-708-B data streams to a video display equipped with a closed caption decoder.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method of selecting symbols on a television display, the method comprising:
receiving a video signal that comprises closed caption data, wherein the closed caption data includes a plurality of symbols;
displaying the closed caption data on the television display;
storing at least portion of the closed caption data in a buffer;
receiving, via a remote control device, first control instructions to maintain the displayed closed caption data on the television display until the occurrence of a selected event, wherein the selected event is one of: receipt of second control instructions to resume the display of the closed captioned data in the video signal, the passage of a predetermined amount of time, or receipt of third control instructions requesting the selection of at least one of the symbols;
receiving, via the remote control device, the third control instructions to select at least one of the symbols;
highlighting the selected symbols on the television display; and
transmitting the selected symbols to a database system.

2. The method of claim 1, wherein the remote control device is hand held.

3. A television, comprising:
a remote control device for receiving control instructions from a user; and
a controller for receiving and displaying a video signal that comprises closed caption data, wherein the closed caption data includes a plurality of symbols, wherein in response to receiving first control instructions from a user, the controller maintains a selected portion of the closed caption data on the television display until the occurrence of a selected event, wherein the selected event is either: receipt of second control instructions to resume the display of the closed caption data in the video signal, the passage of a predetermined amount of time, or receipt of third control instructions requesting the selection of at least one of the symbols, and wherein, in response to receiving, via the remote control device, the third control instructions to select at least one of the symbols, the controller highlights the selected symbols on the television display.

4. The television of claim 3, wherein the controller transmits the selected symbols to a database system.

5. The television of claim 4, wherein the database system is an Internet search engine.

6. The television of claim 4, wherein the remote control device is handheld.

7. A method of selecting symbols on a television display, the method comprising:
receiving a video signal that comprises data, wherein the data includes a plurality of symbols;
displaying one or more of the symbols, wherein the displayed symbols are selectable by a user on a symbol-by-symbol basis;
in response to a user request, maintaining one or more of the displayed symbols on the television display;
in response to a user request, selecting one or more of the displayed symbols on the television display; and
transmitting the selected symbols to a database system.

8. The method of claim 7, wherein the database system is an Internet search engine.

9. The method of claim 7, additionally comprising:
searching the database system for information based at least in part upon the selected symbols; and
displaying the results of the search.

10. The method of claim 7, additionally comprising transmitting the selected symbols over the Internet to a remote computer.

11. The method of claim 7, wherein the video signal is digital.

12. The method of claim 7, additionally comprising highlighting the selected symbols on the television display.

13. The method of claim 7, additionally comprising transmitting the selected symbols to an external device.

14. The method of claim 13, wherein the external device is an information retrieval system.

15. The method of claim 7, additionally comprising storing at least a portion of the received video signal in a buffer.

16. The method of claim 7, wherein the video signal is in accordance with the EIA/CEA-608-B standard.

17. The method of claim 7, wherein the video signal is in accordance with the EIA-708-B standard.

18. The method of claim 7, wherein the user initiates the request to select the symbols by identifying a location on the television display.

19. The method of claim 18, wherein the symbols are selected by determining which of the symbols in the video signal is displayed at the identified location.

20. A television, comprising:
an interface for receiving control instructions from a user; and
a controller for receiving and displaying a video signal that comprises data, wherein the data includes a plurality of symbols, wherein in response to receiving first control instructions from a user, the controller maintains at least some of the symbols on the television display, and wherein the controller receives second control instructions to select one or more of the symbols on the television display.

21. The television of claim 20, wherein the television transmits the selected symbols to a database system.

22. The television of claim 21, wherein the database system is an Internet search engine.

23. The television of claim 21, wherein the database system performs the acts of:
searching for information based at least in portion upon the selected symbols; and
automatically displaying the results of the search.

24. The television of claim 20, wherein the video signal is digital.

25. The television of claim 20, wherein the television transmits the selected symbols over the Internet to a computer.

26. The television of claim 20, wherein the television highlights the selected symbols on a display.

27. The television of claim 20, wherein the television transmits the selected symbols to an external device.

28. The television of claim 20, wherein the controller stores at least a portion of the received video signal in a buffer.

29. The television of claim 20, wherein the user initiates the request to select the symbols by identifying a location on the television display.

30. The method of claim 29, wherein the symbols are selected by determining which symbols are displayed at the identified location.

31. A system for selecting symbols on a television display, the system comprising:
means for receiving a video signal that comprises data, wherein the data includes a plurality of symbols;
means for displaying the data;
means, responsive to a user request, for maintaining a selected portion of the data on the television display; and
means, responsive to a user request, for selecting at least a portion of one of the words on the television display.

32. The system of claim 31, additionally comprising means for transmitting the selected portion to a database system.

33. The system of claim 32, additionally comprising:
means for searching the database system, wherein the selected symbols are used as keywords of the search; and
means for automatically displaying the results of the search.

34. The system of claim 31, additionally comprising means for transmitting the selected symbols over the Internet to a computer.

35. The system of claim 31, additionally comprising means for highlighting the selected symbols on the television display.

36. The system of claim 31, additionally comprising means for transmitting the selected symbols to an external device.

37. The system of claim 36, wherein the external device is an information retrieval system.

38. The system of claim 31, additionally comprising means for storing at least a portion of the received video signal in a buffer.

39. The system of claim 31, wherein the user initiates the request to select the symbols by identifying a location on the television display.

40. The system of claim 39, wherein the symbols are selected by determining which of the words in the video signal is displayed at the identified location.
